(19) United States
(12) Patent Application Publication
(10) Pub. No.: US 2011/0176153 A1
(43) Pub. Date: Jul. 21, 2011

(54) METHOD OF GENERATING A COLOR PROFILE, AN IMAGE PROCESSING DEVICE FOR GENERATING THE COLOR PROFILE, AND A COMPUTER READABLE MEDIUM STORING A CONTROL PROGRAM OF THE IMAGE PROCESSING DEVICE

(75) Inventor: Toru Hoshino, Nakano-ku (JP)

(73) Assignee: KONICA MINOLTA BUSINESS TECHNOLOGIES, INC., Chiyoda-ku (JP)

(21) Appl. No.: 12/982,978

(22) Filed: Dec. 31, 2010

(30) Foreign Application Priority Data
Jan. 15, 2010 (JP) 2010-007296

(51) Int. Cl. H04N 1/60

(52) U.S. Cl. 358/1.9

(57) ABSTRACT

The method in the present invention of generating a color profile for converting color values in a device-independent first color space to color values in a device-dependent second color space for the purpose of color adjustment of an output device comprises the steps of executing the mapping of the extra-gamut color value located outside the gamut of the output device among the color values in the first color space (S206), calculating a color difference (ΔE) between the extra-gamut color value before and after the mapping in S206 (S208), calculating a correction amount (Δh) for correcting the extra-gamut color value before the mapping in S206, based on the color difference (ΔE) calculated in S208 and the extra-gamut color value before the mapping in S206 (S210), executing the re-mapping of the extra-gamut color value after the correction by the correction amount (Δh) calculated in S210 (repeated S206), and generating a color profile for converting the extra-gamut color value before the mapping in S206 to the color value in the second color space corresponding to the extra-gamut color value after the mapping in the repeated S206 (S212).

### CROSS-REFERENCE TO RELATED APPLICATION

This application is based on Japanese Patent Application No. 2010-007296, filed on Jan. 15, 2010, the contents of which are incorporated herein by reference.

### BACKGROUND

1. Technical Field

The present invention relates to a method of generating a color profile for color adjustment of an output device, an image processing device for generating the color profile, and a computer readable storage medium storing a control program of the image processing device.

2. Description of Related Art

An ordinary color printer adopts the technique of mapping the colors outside its gamut into the colors on outer surface of its gamut while reproducing the colors within its gamut, in order to print color images containing the colors outside its gamut. This image mapping technique is generally called as “clipping”. One of the problems involved in the clipping technique is eliminated gradation resulted from concentrative mapping of extra-gamut colors onto the outer surface of the gamut. Nevertheless, ordinary images including most CMYK images and photographic RGB images are less likely to be influenced by the “eliminated gradation” due to the clipping as most of their colors fall within the gamut of a regular color printer.

On the other hand, such RGB images as those created in computer graphics and those containing high intensity colors tend to undergo significant changes in luminosity and colorfulness gradation due to the clipping, and to result in awkward outputs as they contain a large number of colors outside the gamut of a regular color printer. In other words, these RGB images are susceptible to the “eliminated gradation” due to the clipping.

In this context, the Japanese Patent Application Publication No. 2004-32140 discloses a mapping device equipped with a function to correct the hue angle of each color outside the gamut of an output device based on the difference between the gamut of the input device and that of the output devices. More specifically, the mapping device adopts a technique of correcting the hue angle of each color so that the saturated colors within the color space defined by the input device will be equal in hue angle to the saturated colors within the color space defined by the output device.

However, the correction technique based on the difference between the gamuts of the input and output devices, inevitably causes large variations in the correction amount for each color if the gamuts of these devices differ widely from each other (e.g., the input device is an RGB device, and the output device is a CMYK device.) As a result, some of the colors in an input image will be corrected excessively, and therefore deterioration in print quality may occur due to off-balanced gradation in luminosity and colorfulness caused by the excessive correction while the eliminated gradation in the output image will be reduced.

The present invention is intended to solve the aforementioned problem involved in the prior art, and to provide a method of generating a color profile for the purpose of not only reducing the eliminated gradation due to clipping but also maintaining gradation balance in luminosity and colorfulness for the colors within an input image, an image processing device for generating the color profile, and a computer readable medium storing the control program of the image processing device.

### SUMMARY

To achieve one of the above-mentioned objects, the method of generating a color profile for converting color values in a device-independent first color space into color values in a device-dependent second color space for the purpose of color adjustment of an output device, which reflects an aspect of the present invention, comprises the steps of: (A) executing the mapping the extra-gamut color value located outside the gamut of said output device among the color values in said first color space into the surface of said gamut; (B) calculating a color difference between said extra-gamut color value before and after the mapping in said step (A), (C) calculating a correction amount for correcting said extra-gamut color value before the mapping in said step (A), based on said color difference calculated in said step (B) and said extra-gamut color value before the mapping in said step (A), (D) executing the re-mapping of said extra-gamut color value after the correction with said correction amount calculated in said step (C), in accordance with said step (A), and (E) generating a color profile for converting said extra-gamut color value before the mapping in said step (A), into the color value in said second color space corresponding to said extra-gamut color value after the re-mapping in said step (D).

Preferably, said correction amount calculated in said step (C) is an amount for correcting the hue angle of said extra-gamut color value before the mapping in the step (A).

Preferably, said correction amount is calculated in said step (C) by multiplying an initial correction amount defined for each hue angle range where said extra-gamut color value before the mapping in the step (A) belongs to, by a first factor defined for the hue angle of said extra-gamut color value before the mapping in the step (A) and a second factor defined for said color difference calculated in said step (B).

Preferably, said correction amount calculated in said step (C) is an amount for correcting the colorfulness and luminosity values of said extra-gamut color values before the mapping in the step (A).

Preferably, said step (A) includes the steps of: (A1) dividing the extra-gamut area on the luminosity-colorfulness plane corresponding to the hue angle of said extra-gamut color values into a plurality of small segments; (A2) determining as the mapping target value for said extra-gamut color value belonging to the high-colorfulness segment faced with the maximum colorfulness point within said gamut among said small segments created in said step (A1), a certain color value within said gamut having a colorfulness value smaller than said maximum colorfulness point; and (A3) executing the mapping of said extra-gamut color value belonging to said high-colorfulness segment into the intersection between a straight line drawn from said mapping target value determined in said step (A2) to said extra-gamut color value, and the outer surface of said gamut.

Preferably said first color space is the L*a*b* color space.

Preferably said first color space is the CIECAM02 color space.

The objects, features, and characteristics of this invention other than those set forth above will become apparent from the description given below with reference to preferred embodiments illustrated in the accompanying drawings.

### BRIEF DESCRIPTION OF THE DRAWINGS

FIG. 1 is a block diagram showing the structure of a color adjustment system according to an embodiment of the present invention.

FIG. 2 is a block diagram showing the structure of an image forming device according to an embodiment of the present invention.

FIG. 3 is a block diagram showing the structure of an image processing device according to an embodiment of the present invention.

FIG. 4 is a block diagram showing the structure of a measurement device according to an embodiment of the present invention.

FIG. 5 is a flowchart showing steps of the color adjustment according to an embodiment of the present embodiment.

FIG. 6 is a schematic view of a color chart according to an embodiment of the present invention.

FIG. 7 is a conceptual diagram of a device profile according to an embodiment of the present invention.

FIG. 8 is a schematic view of a device profile according to an embodiment of the present invention.

FIG. 9 is a conceptual diagram of a device link profile according to an embodiment of the present invention.

FIG. 10 is a flowchart showing steps of the gamut mapping according to an embodiment of the present invention.

FIG. 11 is a schematic view of the gamut of the image forming device plotted on a C*-L* plane with illustrations of the mapping method according to an embodiment of the present invention.

FIG. 12 is a schematic view of the gamut of the image forming device plotted on a C*-L* plane with illustrations of the mapping method according to an embodiment of the present invention.

FIG. 13A and FIG. 13B are schematic views of the gamut of the image forming device plotted on a*-b* plane with illustrations of the mapping results according to an embodiment of the present invention.

FIG. 14 is a schematic view of the gamut of the image forming device plotted on a*-L* plane with illustrations of the mapping results according to an embodiment of the present invention.

### DETAILED DESCRIPTION

The embodiments of this invention will be described below with reference to the accompanying drawings.

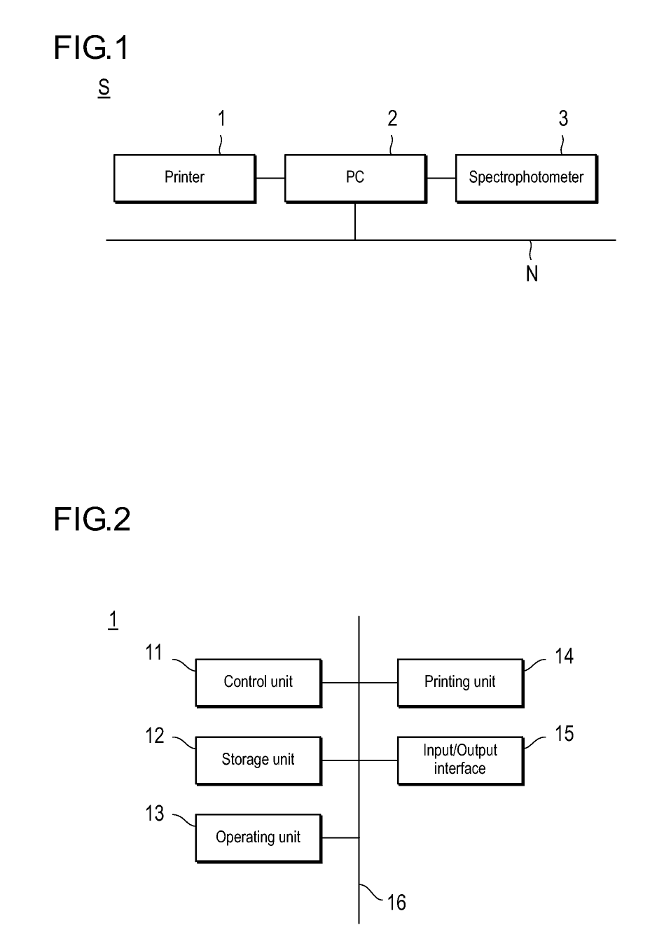

System Structure (FIG. 1-FIG. 4)

FIG. 1 is a block diagram showing the structure of a color adjustment system S, which includes an image processing device according to an embodiment of the present invention. The color adjustment system S according to the present embodiment is a color management system capable of making color adjustment of the image forming device (printer 1) to an output device. In other words, the color adjustment system S is equipped with a function to generate a color profile to be used for color conversion of image data to be output by the printer 1. The output device, which is the target of the color adjustment by the color adjustment system S (hereinafter also referred to as “target device”) is a display unit, such as a CRT display, a liquid crystal display (LCD), and a plasma display (PDP) for outputting (or displaying) images in the RGB color space.

As shown in FIG. 1, the color adjustment system S is equipped with the printer 1, i.e., an image forming device, which is an object of the color adjustment, a PC 2 serving as an image processing device to perform various image processing on image data to be printed by the image forming device, and a spectrophotometer 3 serving, as a measuring device to measure color values of printed images by the image forming device. As shown in FIG. 1, the printer 1 is connected to the PC 2 via a printer cable complying with the IEEE.1284 standards, or a USB cable, the spectrophotometer 3 is connected to the PC 2 via a USB cable, and the PC 2 is connected to a network N such as LAN. The PC 2 can be a standalone device as shown in FIG. 1, or can also be a built-in device of the printer 1. In the latter case, the printer 1 will be directly connected to the network N.

FIG. 2 is a block diagram showing the structure of the printer 1 in FIG. 1. As shown in FIG. 2, the printer 1 includes a control unit 11, a storage unit 12, an operating unit 13, a printing unit 14, and an input/output interface 15, all of which are interconnected via a bus 16 for exchanging signals.

The control unit 11 is a CPU for controlling various units according to control programs. The storage unit 12 is equipped with a ROM for storing various programs, a RAM for temporarily storing various data to serve as a work area, and a hard disk for temporarily storing print data received from the PC 2. The operating unit 13 is an operation panel with a touch panel capable not only of displaying various kinds of information but also receiving various instructions from user, and various fixed keys.

The printing unit 14 is an print engine for printing output images based on image data received from the PC 2 onto a recording medium, by means of the electronic photography including the electric charging, exposing, developing, transferring, and fixing steps. The printing unit 14 can also user other printing methods such as the thermal transfer method and the ink-jet method. The I/O (input/output) interface 15 is an interface for communication with the PC 2. The printer 1 and the PC 2 can also be connected via the network N, and in this case the I/O interface 15 can be an NIC (Network Interface Card) complying with standards like Ethernet®, Token ring, FDDI, etc.

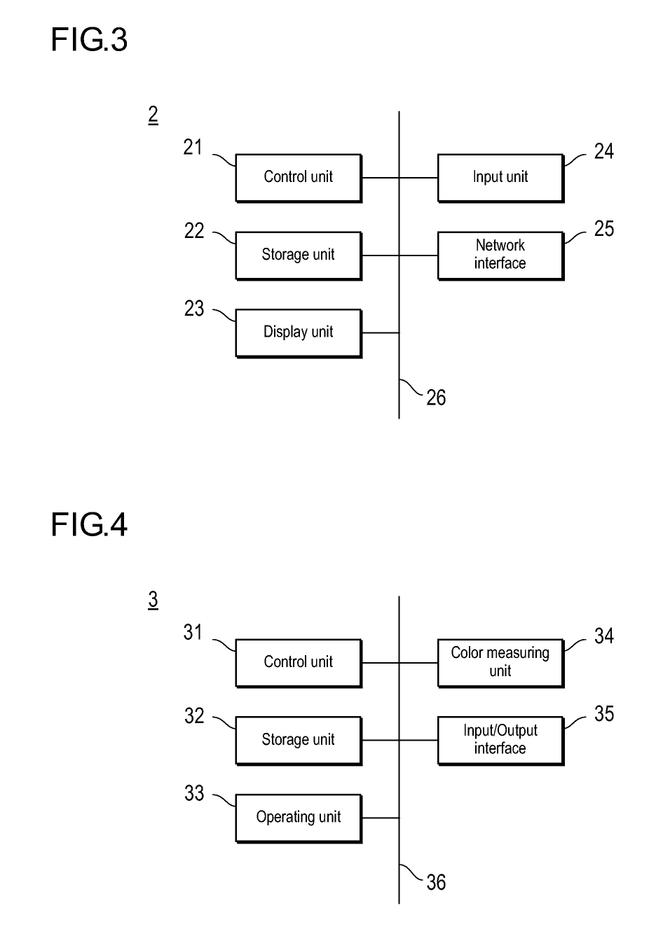

FIG. 3 is a block diagram showing the structure of the PC 2 in FIG. 1. As shown in FIG. 3, the PC 2 includes a control unit 21, a storage unit 22, a display unit 23, an input unit 24, and a network interface 25, all of which are interconnected via a bus 26 for exchanging signals. The PC 2 is designed to receive print data from other devices via the network N, to perform various image processing of the received print data such as RIP and color conversion, and finally to transfer the print data after the image processing to the printer 1. This means that the PC 2 mainly serves as a printer controller of the printer 1.

The control unit 21 is a CPU for controlling various units and performing various calculations according to control programs. In particular, the control unit 11 in the present embodiment executes image processing of the print data received from other devices. The storage unit 22 includes a ROM for storing various programs and parameters for PC 2's basic operations, a RAM for temporarily storing various data to serve as a work area, and a hard disk for storing various programs including the OS. In particular, the hard disk of the storage unit 22 stores various programs for the image processing as well as color profiles used for color conversion.

The display unit 23 is a display device like a CRT display, a liquid crystal display (LCD), a plasma display (PDP) for displaying various kinds of information to user. The input unit 24 is a combination of a keyboard, a mouse and other input devices, and is used by user to give the PC 2 various instructions. The network interface 25 is an interface to connect with a network N for establishing connection with network devices on the network N complying with standards like Ethernet®, Token Ring and FDDI. The network interface 25 is typically a NIC. The PC 2 is also capable of generating color profiles used for the color conversion based on the data received from the spectrophotometer 3.

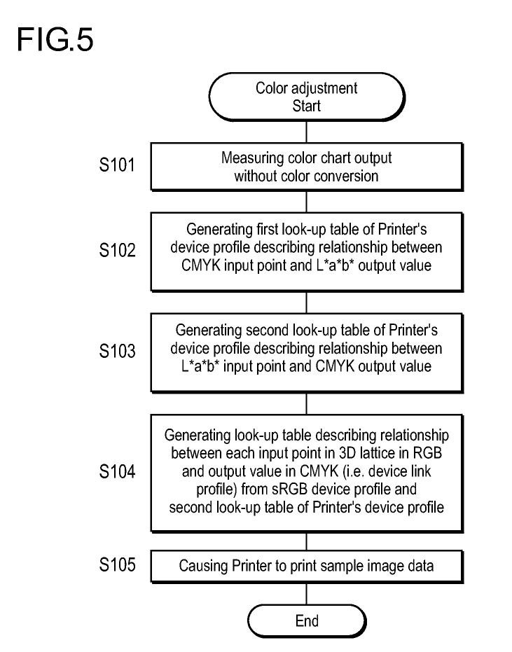

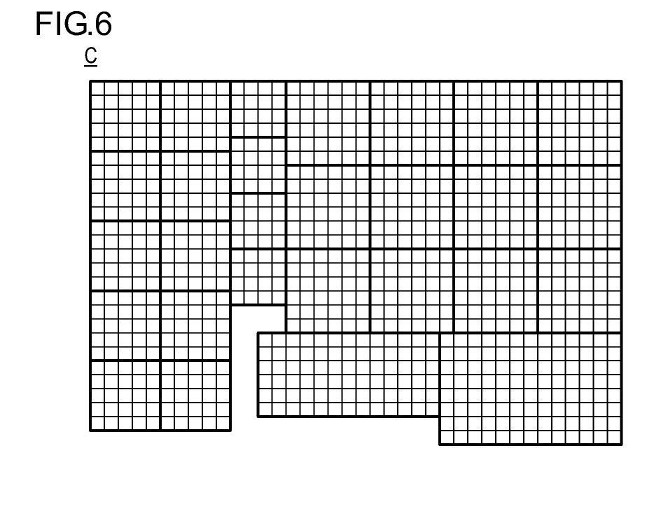

FIG. 4 is a block diagram showing the structure of the spectrophotometer 3 in FIG. 1. As shown in FIG. 4, the spectrophotometer 3 includes a control unit 31, a storage unit 32, an operating unit 33, a color measuring unit 34, and an I/O interface 35, all of which are interconnected via a bus 36 for exchanging signals. The spectrophotometer 3 is designed to measure a color chart printed by the printer 1, and to convert the color measurement data into L*a*b* color values for each of the color patches within the color chart.

The control unit 31 performs various calculations and controls various units according to control programs. The storage unit 32 not only stores various programs and parameters, but also retains the measurement data received from the color measuring unit 34. In particular, the storage unit 32 stores a program for converting the measurement data from the color measuring unit 34 into device-independent color values such as L*a*b* values. The operating unit 33 is a combination of fixed keys for receiving instructions from user.

The color measuring unit 34 is designed to measure each color patch by moving an optical sensor over a color chart, and to transmit the measurement results to the storage unit 32. The color measurement results are then converted into L*a*b* values within the storage unit 32.

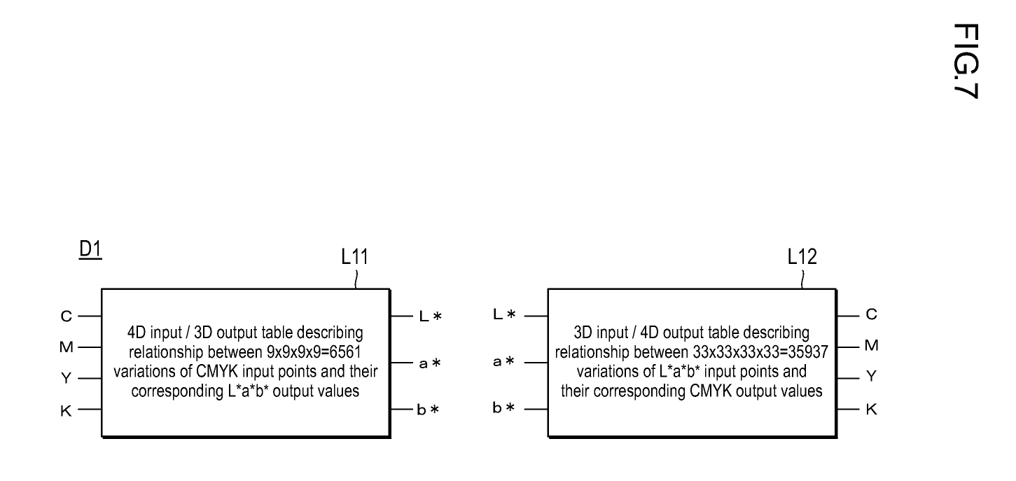

Outline of System Operation (FIG. 5-FIG. 14)

The following is an outline of the operation of the color adjustment system S in the present embodiment. FIG. 5 is a flowchart showing exemplary steps of the color adjustment executed by the PC 2 according to the embodiment of the present invention. This color adjustment is intended to make color adjustment of the printer 1 to the target device by means of color conversion based on a color profile. The algorithm shown in FIG. 5 is stored as a control program in the ROM in the storage unit 22, and is read out to be executed by the control unit 21 when the operation starts.

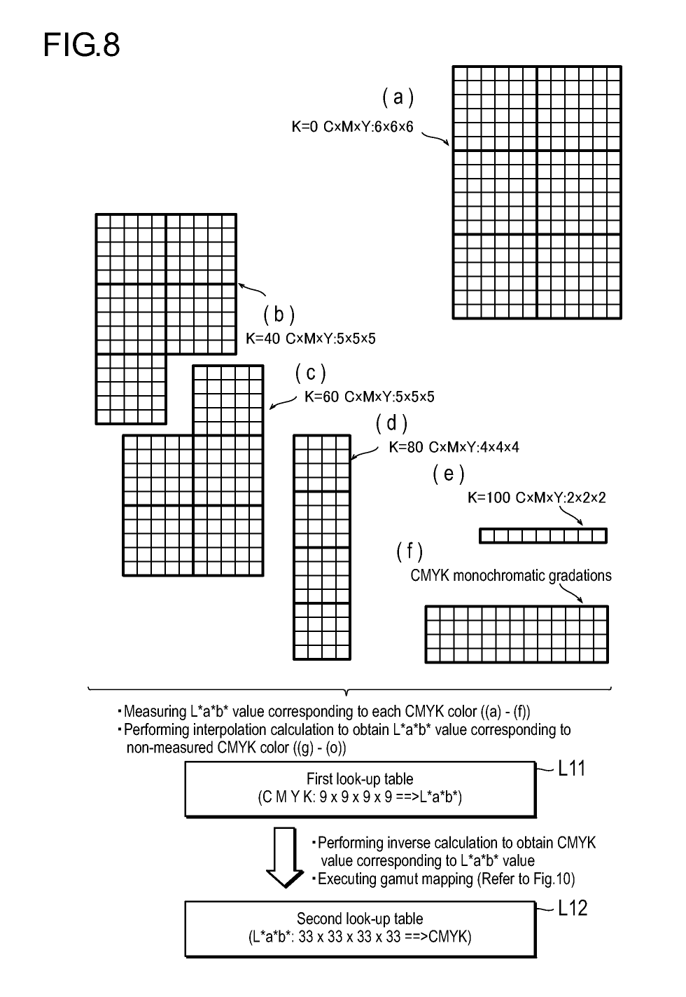

Firstly, the PC 2 causes the printer 1 to print a color chart without executing color conversion based on a color profile, and also causes the spectrophotometer 3 to measure each color patch within the printed color chart (S101). Thus, the PC 2 acquires L*a*b* values corresponding to CMYK values for the color patches. The PC 2 then generates a first look-up table of the device profile for the printer 1, based on the L*a*b* values acquired in S101 (S102), and further generates a second look-up table (S103). The device profile generated in these steps is stored in the storage unit 22. The color chart in the present embodiment is a color chart complying with the ISO12642 standards. FIG. 6 is a schematic view of the color chart C in the present embodiment (Colors in the chart are omitted for simplification. The same applies to FIG. 8.).

FIG. 7 is a conceptual diagram of the device profile D1 for the printer 1 generated in S102 and S103. As shown in FIG. 7, the device profile D1 is a pair of look-up tables (first and second look-up tables L11 and L12). The first look-up table L11 is a 4-dimensional input/3-dimensional output conversion table for converting input points in CMYK into output values in L*a*b*, and contains the output values (L*a*b* values) corresponding to the 6561 input points (CMYK values) wherein the number of the input points is derived from multiplication of CMYK: 9×9×9×9 as shown in FIG. 7. The combination of 9×9×9×9 input points consists of 0%, 10%, 20%, 30%, 40%, 55%, 70%, 85%, and 100% for each of C, M, and Y, and nine points consisting of 0%, 10%, 20%, 30%, 40%, 50%, 60%, 80%, and 100% for K wherein 100% is equivalent to the maximum value. These percentages (%) are chosen in consideration of conformity with the measurement points of the color chart as described later. Each of the CMYK values between 0% and 100% should be associated with any of the 9 sample values, based on each of the C, M, Y, K one-dimension look-up tables. Such an interpolation method as described in the Japanese Patent Application Publication No. 2002-330303 can also be used for acquiring output values corresponding to other input points than the above-mentioned 6561 CMYK values.

The second look-up table L12 is a 3-dimensional input/4-dimensional output conversion table for converting input points in L*a*b* into output values in CMYK, and contains the output values (in CMYK) corresponding to 35973 input points (in L*a*b*) wherein the number of the 35973 input points is derived from multiplication of L*a*b*: 33×33×33×33 as shown in FIG. 7.

The first look-up table is also called as input conversion table as it is used at the input side of the color conversion, and the second look-up table is also called as output conversion table as it is used at the output side of the color conversion. These synonyms for these tables will also be used in the following descriptions. The PC 2 can generate various kinds of different color profiles with different rendering intents such as “colorimetric”, “perceptual”, and “saturation”.

The following is a detailed description of the method of generating the device profile D1 in S102 and S103 shown in FIG. 8. Firstly, the PC 2 in the present embodiment generates the first look-up table L11 in accordance with the steps (I) to (III) as follows:

(I) Causing the color measuring device to measure the L*a*b* color values corresponding to the following CMYK colors contained in the printed color chart:

(a) C×M×Y: 6×6×6 with K=0% (0%, 10%, 20%, 40%, 70%, 100% for each of C, M, Y)

(b) C×M×Y: 5×5×5 with K=40% (0%, 20%, 40%, 70%, 100% for each of C, M, Y)

(c) C×M×Y: 5×5×5 with K=60% (0%, 20%, 40%, 70%, 100% for each of C, M, Y)

(d) C×M×Y: 4×4×4 with K=80% (0%, 40%, 70%, 100% for each of C, M, Y)

(e) C×M×Y: 2×2×2 with K=100% (0%, 100% for each of C, M, Y)

(f) Monochromatic gradations for each of C, M, Y,

K (13 steps: 3%, 7%, 10%, 15%, 20%, 25%, 30%, 40%, 50%, 60%, 70%, 80%, and 90% for each color)

(II) Calculating L*a*b* color values corresponding to the CMYK colors shown in the following paragraphs (g) to (k) using the measured L*a*b* values in the step (I) corresponding to the CMYK colors shown in the paragraphs (a) to (e). Also calculating L*a*b* values for non-measured CMYK colors in the step (I) by means of an interpolation method based on the measurements of their adjacent colors as well as the measurements of the monochromatic gradations shown in the paragraph (f).

(g) C×M×Y: 9×9×9 with K=0% (0%, 10%, 20%, 30%, 40%, 55%, 70%, 85%, 100% for each of C, M, Y)

(h) C×M×Y: 9×9×9 with K=40% (0%, 10%, 20%, 30%, 40%, 55%, 70%, 85%, 100% for each of C, M, Y)

(i) C×M×Y: 9×9×9 with K=60% (0%, 10%, 20%, 30%, 40%, 55%, 70%, 85%, 100% for each of C, M, Y)

(j) C×M×Y: 9×9×9 with K=80% (0%, 10%, 20%, 30%, 40%, 55%, 70%, 85%, 100% for each of C, M, Y)

(k) C×M×Y: 9×9×9 with K=100% (0%, 10%, 20%, 30%, 40%, 55%, 70%, 85%, 100% for each of C, M, Y)

(III) Calculating L*a*b* color values for the CMYK colors shown in the paragraphs (1) to (n), by means of an interpolation based on the L*a*b* color values obtained in the step (II) for the CMK colors shown in the paragraphs (g) to (h) above and the L*a*b* color values obtained in the step (I) for the K monochromatic gradations shown in the paragraph (f) above, and further calculating L*a*b* color values for the CMYK colors shown in the paragraph (o) below by means of an interpolation based on the L*a*b* color values obtained in the step (II) for the CMYK colors shown in the paragraphs (h) to (i) above and the L*a*b* color values obtained in the step (I) for the K monochromatic gradations shown in the paragraph (f).

(l) C×M×Y: 9×9×9 with K=10% (0%, 10%, 20%, 30%, 40%, 55%, 70%, 85%, 100% for each of C, M, Y)

(m) C×M×Y: 9×9×9 with K=20% (0%, 10%, 20%, 30%, 40%, 55%, 70%, 85%, 100% for each of C, M, Y)

(n) C×M×Y: 9×9×9 with K=30% (0%, 10%, 20%, 30%, 40%, 55%, 70%, 85%, 100% for each of C, M, Y)

(o) C×M×Y: 9×9×9 with K=50% (0%, 10%, 20%, 30%, 40%, 55%, 70%, 85%, 100% for each of C, M, Y)

This is how the PC 2 in the present embodiment calculates a L*a*b* color value for each of C×M×K: 9×9×9×9 in order to generate the first look-up table L11 for converting CMYK values into L*a*b* color values.

The following is a description of the method of generating the second look-up table L12 shown in FIG. 8. The second look-up table L12 is a 3-dimensional input/4-dimensional output conversion table for conversing input points in L*a*b* into output values in CMYK, and is generated by means of an inverse calculation of CMYK color values from L*a*b* color values.

An exemplary method of the inverse calculation used in the present embodiment is described in the Japanese Patent Application Publication No. 2003-78773. More specifically, the PC 2 generates a relational table between each of C×M×Y and its corresponding L*a*b* value with reference to a formula for acquiring K values from C, M, Y values, and acquires the CMY value corresponding to each of the 33×33×33 L*a*b* values based on that relational table. The PC 2 then acquires the K values according to the acquired CMY values in accordance with a relevant formula. The following formula (1) shown below is an exemplary formula for acquiring K values from CMY values:

Formula (1):

K=1.6×(min[C, M, Y]−128) (1)

The formula (1) assumes that each of the C, M, Y, K values should fall within the range between 0 and 255. The formula (1) also includes the function “min[C, M, Y]” for returning the smallest value among C, M, Y. The acquired K value should be replaced by “K=0” if it turns out to be “K<0”.

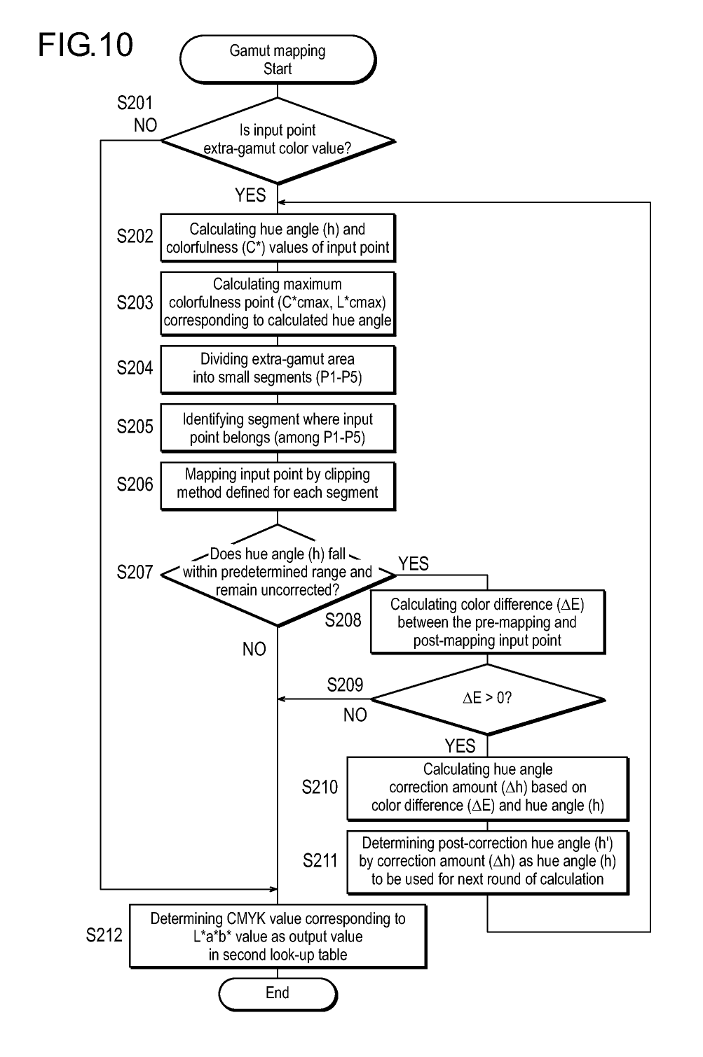

The CMYK values thus acquired are determined as the output values of the second look-up table L12. If the input point in L*a*b* is located outside the gamut of the printer 1, the PC 2 executes the gamut mapping in order to obtain a CMYK value corresponding to the post-mapping L*a*b* value, and determine the obtained CMYK value as the output value of the second look-up table L12. The detailed procedure for the gamut mapping according to the present embodiment will be described later (FIG. 10).

Next, the PC 2 combines to the input profile for the target device and the output conversion table L12 generated in S103 to generate a device link profile D2 (S104). In this example, the PC 2 uses as the input profile for the target device, the sRGB profile complying with the international standards defined by the International Electrotechnical Commission (IEC).

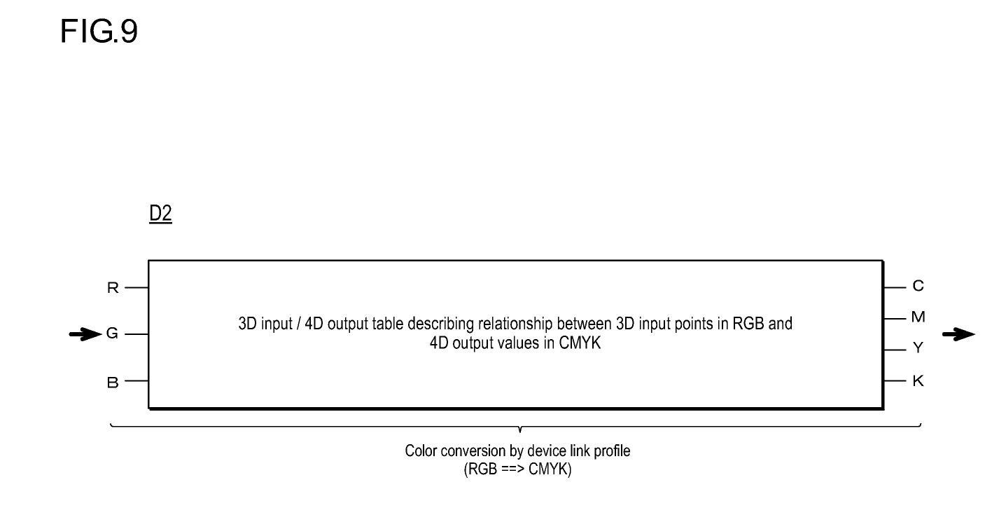

FIG. 9 is a conceptual diagram of an exemplary device link profile D2. As shown in FIG. 9, the device link profile D2 is a 3-dimensional input/4-dimensional output conversion table describing relationship between input points in RGB and output values in CMYK. The output values of the device link profile D2 are equal to the CMYK values obtained in the following steps: converting the RGB input points into L*a*b* value using the sRGB profile, and further converting the L*a*b* value using the output conversion table L12.

Next, the PC2 converts sample RGB image data into CMYK image data, using the device link profile D2 generated in S104, and causes the printer 1 to output the CMYK image data (S105). Color conversion using the device link profile D2 will shorten the processing time of the PC 2 in comparison with gradual application of both the RGB input profile and the output conversion table of the printer 1.

FIG. 10 is a flowchart showing exemplary steps of the aforementioned gamut mapping. The PC 2 executes the series of steps shown below for each of the input points (L*a*b* values) of the output conversion table L12 of the device profile D1 for the printer 1.

Firstly, the PC 2 makes a judgment as to whether or not the input point currently under the processing is located outside the gamut of the printer 1 (i.e. whether or not the input point is an extra-gamut color value) (S201). The judgment method described in the Japanese Patent Application Publication No. 2003-78773 can be used, for example. If the current input point is not an extra-gamut color value (S201: No), the PC 2 doesn't have to execute the gamut mapping for the current input point, and therefore it acquires a CMYK value corresponding to the input L*a*b* value without executing the gamut mapping to determine the acquired CMYK value as the output value of the second look-up table L12 (S212). After that, the PC 2 terminates the gamut mapping for the current input point (End), and moves on to the gamut mapping for the next input point.

On the other hand, if the current input point is an extra-gamut color value (S201: Yes), the PC 2 calculates an output value of the output conversion table L12 corresponding to the current input point in accordance with the procedure described in S202 and thereafter. Firstly, the PC 2 calculates the hue angle (h) and colorfulness (C*) values of the current input point in accordance with the following formulas (2) and (3), respectively (S202):

Formula (2):

h=arc tan(b*/a*)/n×180 (2)

Formula (3):

C*={(a*)2+(b*)²}^{0.5} (3)

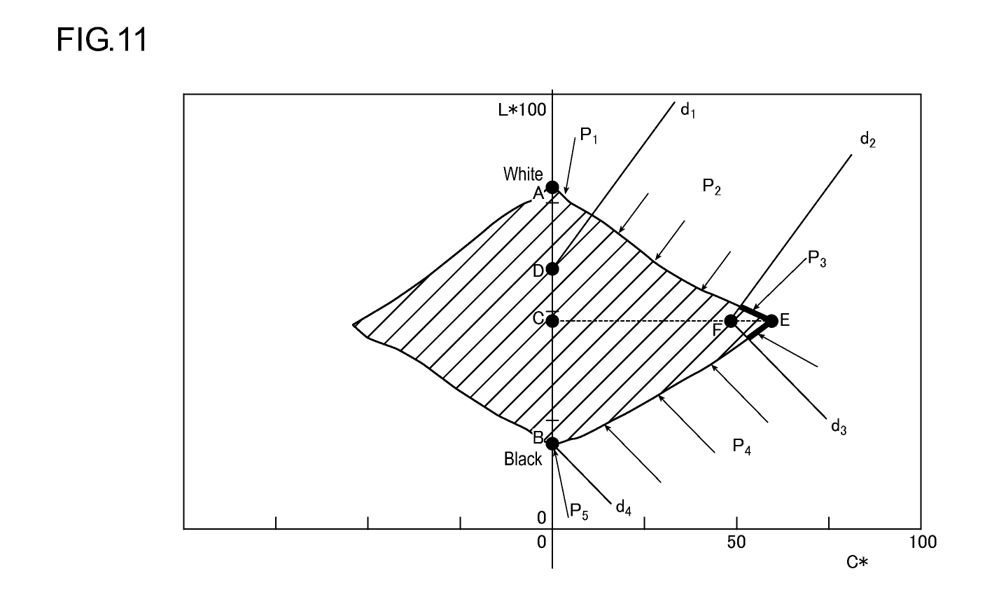

The PC 2 then refers to the calculation results in step S202 to further calculate the colorfulness value (C*_{cmax}) and the luminosity value (L*_{cmax}) at the maximum colorfulness point corresponding to the hue angle (h) of the current input point (S203). The maximum colorfulness herein refers to the point on a colorfulness-luminosity plane (C*-L* plane) representing the maximum colorfulness value within the gamut according to the relevant hue angle. FIG. 11 is a schematic view of the gamut of the printer 1 expressed on a C*-L* plane. The hatched area on the C*-L* plane shows the gamut of the printer 1, and the point “E” represents the maximum colorfulness point corresponding to the relevant hue angle. In this example, the luminosity value (L*_{cmax}) and the colorfulness value (C*_{cmax}) at the maximum colorfulness point are calculated in accordance with the steps (I) and (II) as follows:

(I) Obtaining from the output conversion table L12, input points (L*a*b* values) corresponding to the following output values (CMYK values). Then calculating hue angle and colorfulness values for each of the obtained L*a*b* values in accordance with aforementioned formulas (1) and (2):

9 CMYK values between (0, 100, 0, 0) and (0, 100, 100, 0) with gradually increased Y values;

9 CMYK values between (0, 100, 100, 0) and (0, 0, 100, 0) with gradually increased M values;

9 CMYK values between (0, 0, 100, 0) and (100, 0, 100, 0) with gradually increased C values;

9 CMYK values between (100, 0, 100, 0) and (100, 0, 0, 0) with gradually increased Y values;

9 CMYK values between (100, 0, 0, 0) and (100, 100, 0, 0) with gradually increased M values; and

9 CMYK values between (100, 100, 0, 0) and (0, 100, 0, 0) with increased C values

(II) Obtaining colorfulness and luminosity values corresponding to the hue angle (h) of the current input point by means of the interpolation based on the calculation results of the luminosity value (L*), the hue angle and the colorfulness value. Then determining the obtained colorfulness and luminosity values as the colorfulness and luminosity values (C*_{cmax}, L*_{cmax}) at the maximum colorfulness point corresponding to the hue angle (h) of the current input point.

In FIG. 10, the PC 2 divides the area outside the gamut of the printer 1 (hereinafter also referred to as “extra-gamut area”) on the C*-L* plane corresponding to the hue angle (h) into a plurality of segments (S204). In the example in FIG. 11, the PC 2 divided the extra-gamut area into five segments (P₁ to P₅). Details on these segments (P₁ to P₅) in this example are shown below.

P₁: an extra-gamut segment between a straight line “d₁” with a tilt “p” (p>0) drawn in the positive direction of the L* axis from the target white point “D” located between the luminosity midpoint “C” and the maximum white point “A”, and the L* axis

P₂: an extra-gamut segment between a straight line “d₂” with the tile “p” drawn in the positive direction of the L* axis from the target high-colorfulness point “F” located between the maximum colorfulness point “E”, and the straight line “d₁”

P₃: an extra-gamut segment between a straight line “d₃” with a tilt “q” (q<0) drawn in the negative direction of the L* axis from the target high-colorfulness point “F”, and the straight line “d₂”

P₄: an extra-gamut segment between a straight line “d4” with the tilt “q” drawn in the negative direction of the L* axis from the maximum black point “B”, and the straight line “d₃”

P₅: an extra-gamut segment between the L* axis and the straight line “d₄”

Next, the PC 2 identifies the specific segment where the current input point belongs among the segments P₁-P₅ created in S204 (S205). For example, the specific segment can be identified from magnitude relation between the luminosity value (L*) of the current input point and the luminosity value (L*_{cmax}) of the maximum colorfulness point as well as magnitude relation between the tile a_{XD}, a_{XF}, a_{XB} of the straight lines XD, XF, XB on the C*-L* plane drawn from the input point (X) to the target white point “D”, the target high-colorfulness point “F”, the maximum black point “B”, respectively, and the aforementioned tilts “q”. The specific determination procedure is shown below in more detail.

If the condition “L*≧L*_{cmax}” is true, the input point shall belong to any one of P₁, P₂, P₃.

If the condition “a_{XD}≧p” is still true, the input point shall belong to P₁.

If the condition “a_{XF}≦p” is still true, the input point shall belong to P₃.

In the other cases, the input point shall belong to P₂.

If the condition “L*<L*_{cmax}” is true, the input point shall belong to any one of P₃, P₄, P₅.

If the condition “a_{XF}≧q” is still true, the input point shall belong to P₃.

If the condition “a_{XF}≦q” is still true, the input point shall belong to P₅.

In the other cases, the input point shall belong to P₄.

Next, the PC 2 execute the mapping of the current input value into a L*a*b* value within the gamut by means of the specific clipping method defined for each of the segments P₁-P₅ on the C*-L* plane (S206). Table 1 below shows an example of the clipping method for each of the segments P_{1 to P}₅.

TABLE 1

| Segment | Clipping method per segment (in FIG. 11) |
|---|---|
| P₁ | Mapping the input point into the intersection |
| | between the straight line drawn from the input point |
| | (X) to the target white point “D”, and the outer |
| | surface of the gamut. |
| P₂ | Mapping the input point into the intersection |
| | between the straight line with the tilt “p” passing |
| | through the input point (X), and the outer surface |
| | of the gamut. |
| P₃ | Mapping the input point into the intersection |
| | between the straight line drawn from the input point |
| | (X) to the target high-colorfulness point “F”, and |
| | the outer surface of the gamut. |
| P₄ | Mapping the input point into the intersection |
| | between the straight line with the tilt “q” passing |
| | through the input point (X), and the outer surface |
| | of the gamut. |
| P₅ | Mapping the input point into the maximum black point |
| | “B”. |

In the example in FIG. 11, the PC 2 adopt the clipping method of mapping the input points within the extra-gamut segment P₃ between the straight lines “d₂” and “d₃” both drawn from the maximum colorfulness point “E” with the tilts “p” (P>0) and “q” (q<0), respectively, toward the target high-colorfulness point “F” with a smaller colorfulness value than the maximum colorfulness point “E”, instead of the conventional clipping method of mapping the input points within the segment P₃ uniformly into the maximum colorfulness point “E”. The clipping method in the present embodiment ensures that the luminosity difference between input points within the segment P₃ will be properly maintained as the post-mapping input points are dispersed on the thick line shown in FIG. 11 while the conventional clipping method involves elimination of the luminosity difference after the mapping as the luminosity values (L*) of all the input points within the segment P₃ end up being equal to L*_{cmax}.

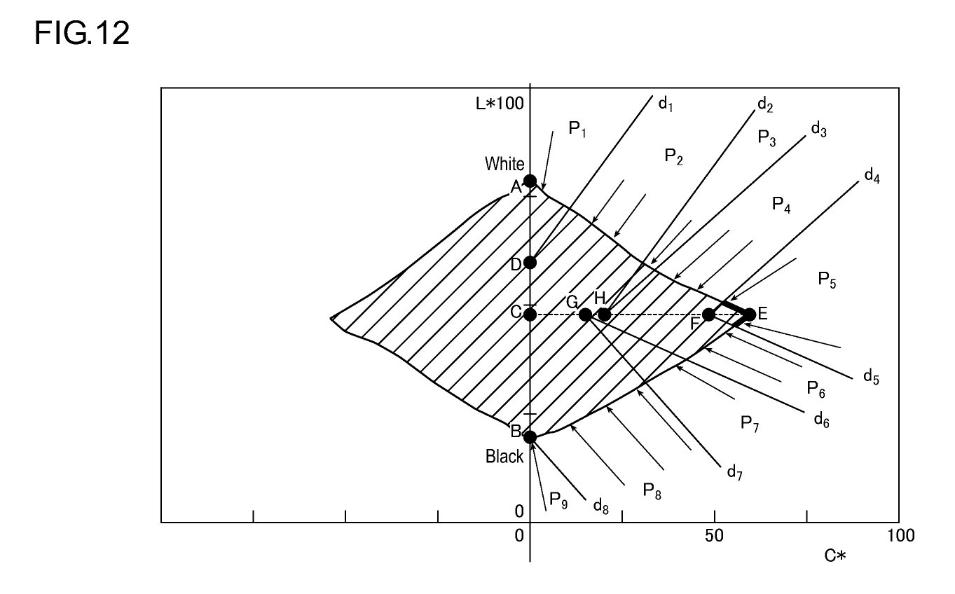

FIG. 11 only shows an example of the clipping methods applicable to the present embodiment. The PC 2 in the present embodiment can also adopt a clipping method involving finer segmentation of the extra-gamut area as shown in FIG. 12. Description of the finer segments P₁-P₉ in FIG. 12 is shown below, and the specific clipping method for each of these segments is given in Table 2.

P₁: an extra-gamut segment between a straight line “d₁” with a tilt “p₁”(p₁>0) drawn in the positive direction of the L* axis from the target white point “D” located between the luminosity midpoint “C” and the maximum white point “A”, and the L* axis

P₂: an extra-gamut segment between a straight line “d₂” with the tilt “p₁” drawn from the target mid-colorfulness point “H” in the positive direction of the L* axis, and the straight line “d₁”

P₃: an extra-gamut segment between a straight line “d3” with a tilt “P₂” drawn from the target mid-luminosity point “H” in the positive direction of the L* axis, and the straight line “d₂”

P₄: an extra-gamut segment between a straight line “d₄” with the tilt “p₂” drawn in the positive direction of the L* axis from the target high-colorfulness point “F”, and the straight line “d₃”

P₅: an extra-gamut segment between a straight line “d₅” with a tilt “q₁” (q₂<0) drawn in the negative direction of the L* axis from the target high-colorfulness point “F”, and the straight line “d₄”

P₆: an extra-gamut segment between a straight line “d₆” with the tilt “q1” drawn in the negative direction of the L* axis from the target mid-luminosity point “G” located between the Luminosity midpoint “G” and the target mid-luminosity point “H”, and the straight line “d₅”

P₇: an extra-gamut segment between a straight line “d₇” with a tilt “q₂” (q₂<q₁) drawn in the negative direction of the L* axis from the target mid-luminosity point “G”, and the straight line “d₆”

P₈: an extra-gamut segment between a straight line “d₈” with the tilt “q₂” drawn in the negative direction of the L* axis from the maximum black point “B” on the L* axis, and the straight line “d₇”

P₉: an extra-gamut segment between the L* axis and the straight line “d₈”

TABLE 2

| Segment | Clipping method per segment (in FIG. 11) |
|---|---|
| P₁ | Mapping the input point into the intersection |
| | between the straight line drawn from the input point |
| | (X) to the target white point “D”, and the outer |
| | surface of the gamut. |
| P₂ | Mapping the input point into the intersection |
| | between the straight line with the tilt “p₁” passing |
| | through the input point (X), and the outer surface |
| | of the gamut. |
| P₃ | Mapping the input point into the intersection |
| | between the straight line drawn from the input point |
| | (X) to the target mid-colorfulness point “H”, and |
| | the outer surface of the gamut. |
| P₄ | Mapping the input point into the intersection |
| | between the straight line with the tilt “p₂” passing |
| | through the input point (X), and the outer surface |
| | of the gamut. |
| P₅ | Mapping the input point into the intersection |
| | between the straight line drawn from the input point |
| | (X) to the target high-colorfulness point “F”, and |
| | the outer surface of the gamut. |
| P₆ | Mapping the input point into the intersection |
| | between the straight line with the tilt “q₁” passing |
| | through the input point (X), and the outer surface |
| | of the gamut. |
| P₇ | Mapping the input point into the intersection |
| | between the straight line drawn from the input point |
| | (X) to the target mid-colorfulness point “G”, and |
| | the outer surface of the gamut. |
| P₈ | Mapping the input point into the intersection |
| | between the straight line with the tilt “q₂” passing |
| | through the input point (X), and the outer surface |
| | of the gamut. |
| P₉ | Mapping the input point into the maximum black point |
| | “B”. |

Next, the PC 2 correct hue angle (h) of the input point after the mapping in S206 in accordance with the procedure of S207 and thereafter. It is common knowledge that unlike the gamut of an input RGB device, the gamut of an ordinary color printers tend to be smaller in the hue angle range between 310° and 360° (corresponding to the range between Magenta and Red) than in the other hue angle ranges while its area on a C*-L* plane generally varying with hue angle.

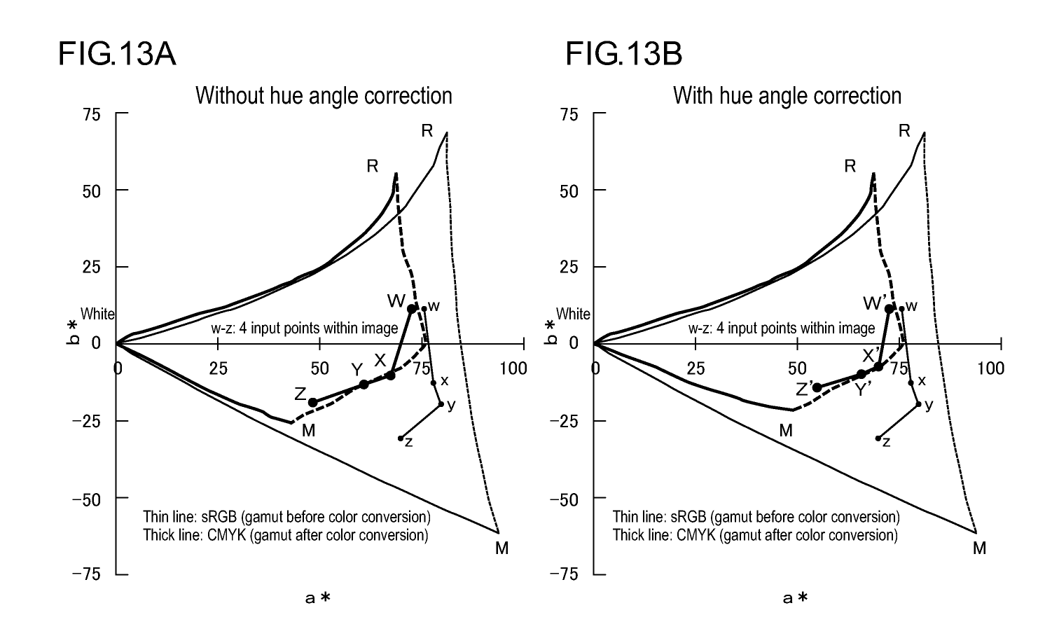

FIG. 13A is a schematic view of the gamut of the printer 1 on an a*-b* plane. Thick lines in the diagram represent the gamut of the printer 1 while thin lines in the diagram represent the gamut of the target device (RGB device) for comparison. FIG. 13A shows that the part of the gamut of the printer 1 corresponding to the aforementioned hue angle range (310°<h<360°) is particularly smaller compared to that of the input RGB device. In other words, an input point belonging to the hue angle range undergoes large decrease in colorfulness due to the clipping. More specifically study on the positional relationship between the pre-mapping input points w, x, y, z and their corresponding post-mapping inputs points W, X, Y, Z in FIG. 13A reveals that the pre-mapping input points x, y, z belonging to the aforementioned hue angle range undergo much larger decrease in colorfulness than the pre-mapping input point not belonging to the hue angle range.

As a counter measure to this defect, the PC 2 according to the present embodiment alleviates the colorfulness decrease due to the clipping by means of correcting the hue angle (h) of the post-mapping input point in accordance with the steps shown below so that the two-dimensional gamut will become larger. Firstly, the PC 2 makes a judgment as to whether or not the hue angle (h) calculated in S202 belongs to a predetermined range (S207). The predetermined range herein refers to the hue angle range where the two-dimensional gamut becomes especially smaller as described above, and is typically the range between 310° and 340° (310°<h<340° in this example. If the hue angle (h) falling within the predetermined range (S207: Yes), the PC 2 then calculates the color difference (ΔE) between the input points before and after the mapping in S206 in accordance with the following formula (4) (S208). In this formula the L*a*b* value (L*0, a*0, b*0) represents that of a pre-mapping input point, and the L*a*b* value (L*₁, a*₁, b*₁) represents that of the post-mapping input point.

Formula (4):

ΔE=((L*₀−L*₁)²+(a*₀−a*₁₎²+(b*₀−b*₁)²)^{0.5} (4)

On the other hand, if the hue angle (h) does not fall within the predetermined range (S207: No), the PC 2 does not correct the hue angle (h) and determines the CMYK value corresponding to the post-mapping L*a*b* value (L*₁, a*₁, b*₁) as the output value in the second look-up table L12 (S212). Next, the PC 2 terminates the gamut mapping for the current input point (End), and moves on to the gamut mapping for the next input point.

The PC 2 then makes a judgment as to whether or not the color difference (ΔE) calculated in S208 is greater than 0 (S209). The PC 2 then corrects the hue angle (h) in accordance with the steps shown below if the calculated color difference (ΔE) is greater than 0 (S209: Yes), while determining the CMYK value corresponding to the post-mapping L*a*b* value as the output value in the second look-up table L12 without correcting the hue angle (h) (S212) if the color difference (ΔE) is equal to 0 (S209: No). Unlike S209 in which the PC 2 uses “0” as a judgment criterion, the PC 2 in present embodiment can also make a judgment as to whether or not the calculated color difference is greater than a predefined threshold value “t” (e.g., t=1).

Next, the PC 2 calculates the correction amount (Δh) of the hue angle (h) based on the color difference (ΔE) calculated in S208 (S210). More specifically, the PC 2 calculates the hue angle correction amount (Δh) in accordance with the following formula (5):

Formula (5):

Δh=8×c₁×c₂ (5)

The first factor “c₁” and the second factor “c₂” in the formula (5) are weight factors selected according to the hue angle (h) of the input point, and the color difference (ΔE) between pre-mapping and post-mapping input points, respectively. Relationship between hue angle (h) ranges of the input point and first factor (c₁) values is shown in Table 3 for example. Relationship between color difference (ΔE) ranges between the pre-mapping and post-mapping input points and second factor (c₂) values is shown in Table 4 for example. Although the initial correction amount before multiplication by the two factors is “8” in the formula (5), this value can be selected in an arbitrary manner. As can be seen from the above, the correction amount (Δh) of the hue angle (h) for the current input point is calculated by multiplication of a certain initial correction amount by the first factor (c₁) according to the hue angle (h) of the input point and the second factor (c₂) according to the color difference (ΔE) between the pre-mapping and post-mapping input points.

TABLE 3

| hue angle range (h) | First factor (c₁) |
|---|---|
| 310° ≦ h < 320° | c₁ = (h − 310)/(320 − 310) |
| 320° ≦ h < 345° | c₁ = 1 |
| 345° ≦ h < 360° | c₁ = (360 − h)/(360 − 345) |

TABLE 4

| Color difference range (ΔE) | Second factor (c₂) |
|---|---|
| ΔE < 5 | c₂ = ΔE/5 |
| ΔE ≧ 5 | c₂ = 1 |

The reason for applying the two different weight factors in formula (5) is to achieve continuous distribution of the hue angles (h′) of the post-correction input points. The following is an example calculation of the correction amount for an input point with the L*a*b* value (54.3, 86.4, −56.0) resulting in the hue angle (h) being 327°, the colorfulness value (C*) being 103, and the color difference value (ΔE) being 50. The calculation of the correction amount (Δh) turns out “8” in accordance with the formula (5) and the values shown in Table 3 and Table 4 (i.e. Δh=8×1×1=8). Therefore, the hue angle (h′) after the correction turns out to be “335°” (i.e. h′=327°+8°=335°.

Next, the PC 2 move onto the procedure from S202 to S206 with respect to the post-correction input point with the corrected hue angle (h′) derived from the correction amount (Δh) acquired in S210. In the latest round of the procedure from S202 to S206, the PC 2 adopts the uncorrected luminosity (L*) and colorfulness (C*) values (L*=54.3, C*=103) as the luminosity and colorfulness values for the post-correction input point. The a* and b* values for the post-correction input point are calculated in accordance with following formulas (6) and (7) shown below.

The PC 2 then determines the CMYK value corresponding to the post-mapping L*a*b* value after the re-mapping of the post-correction input value in the latest S206 as the output value in the second look-up table L12 (S212). Finally, the PC 2 terminates the gamut mapping for the current input point (End), and moves on to the gamut mapping for the next input point.

Formula (6):

a*=C*×cos(h′/180×n) (6)

Formula (7):

b*=C*×sin(h′/180×n) (7)

FIG. 13B is a schematic view of the gamut of the printer 1 after the aforementioned gamut mapping. The input points w, x, y, z shown in the diagram are identical with those shown in FIG. 13A. The input points W′, X′, Y′, Z′ also shown in the diagram are the post-correction input points corresponding to the uncorrected inputs points W, X, Y, Z in FIG. 13A. The two diagrams indicate that the correction of the hue angle (h) effectively alleviates the decreased colorfulness of the input points x, y, z.

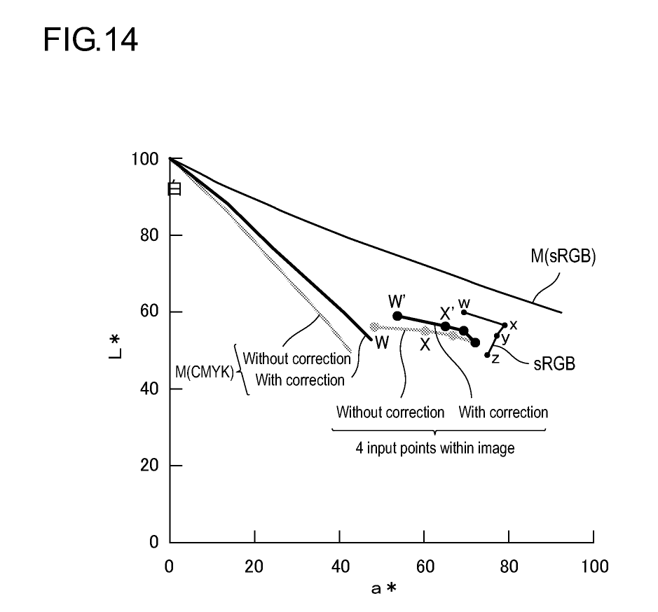

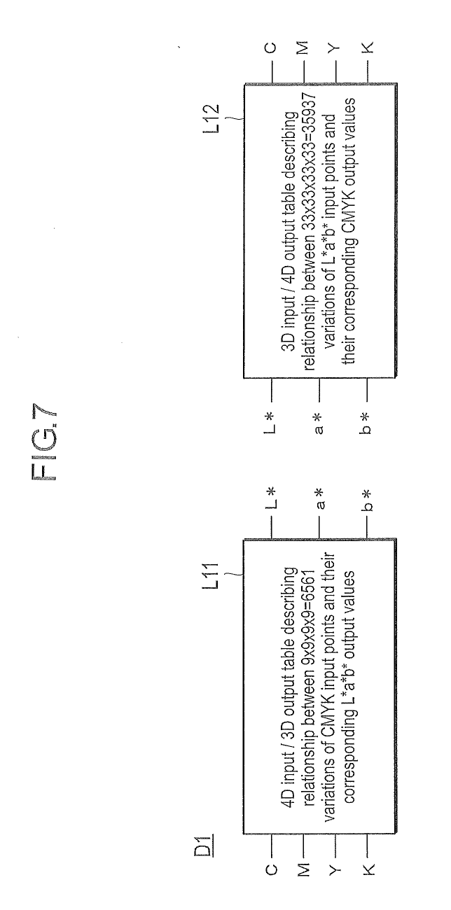

FIG. 14 is a schematic view of the positional relationship on the a*-L* plane between the pre-mapping input points w, x, y, z and the post-mapping input points W, X, Y, Z according to the clipping method shown in FIG. 11 as well as the positional relationship between the pre-mapping input points w, x, y, z and the post-mapping input points W′, X′, Y′, Z′ after the hue angle correction shown in FIG. 10. The diagram in FIG. 14 reveals that luminosity values (L*) of these input points become larger after the hue angle correction, and therefore the luminosity difference between the adjacent input points becomes broader. This is because the reproducible range of luminosity has been extended in the direction of higher luminosity as a result of the hue angle correction toward broader gamut area.

While the descriptions from FIG. 11 to FIG. 14 relate to the hue angle correction of the inputs points belonging to the specific hue angle range between Magenta and Red and its vicinity, the PC 2 in the present embodiment can also adopt the same correction method to the input points belonging to any other hue angle ranges. In this respect, it is known that bluish input colors in a RGB color space are likely to become red-tinted in a CMYK color space after the ordinary gamut mapping, due to the distortional contour of the L*a*b* color space. The correction method according to the present embodiment can also be applied so that the hue angles of bluish inputs colors in RGB are corrected to be smaller for the purpose of alleviating the red-tinted output in CMYK.

As observed above, the PC 2 for generating a color profile in the present embodiment calculates the correction amount (Δh) for each of the extra-gamut inputs points in the first color space based on the color difference (ΔE) before and after the clipping, and then determines as the output value of the color profile, the color value in the second color space corresponding to the post-mapping color value resulted from the remapping of the corrected input points by the calculated correction amount (Δh). Therefore, the PC 2 in the present embodiment can effectively prevent the fluctuation of the correction value (Δh) by color even if the gamut shape of the input and output devices differs significantly from each other like in a case where the target device is an RGB device. Consequently, the present invention can not only alleviate the decreased degradation due to clipping, but also maintain the luminosity and colorfulness balance in an appropriate manner.

The invention is not limited to the embodiment described above, and hence it can be modified in various ways within the scope of the appended claims. For example, the aforementioned embodiment adopts the L*a*b* color space as a device-independent color space for the color conversion process, but it can also apply other device-independent color spaces such as the CIECAM02 color space. Also, the aforementioned embodiment assumes that the hue angle (h) of the input point is corrected based on the color difference before and after the clipping, but the colorfulness and luminosity values of the input point can also be corrected in a similar manner.

The image processing device according to the invention can be implemented by a dedicated hardware circuit for executing the abovementioned steps, or a computer program run by a CPU for executing these steps. If the present invention is implemented by the latter, the programs for driving the image processing device can take the form of a computer-readable recording medium such as a floppy® disk and CD-ROM, or a downloadable file via a network such as the Internet. The program stored in the computer readable recording medium is normally transported to a memory device such as a ROM and a hard disk. The program can also take the form of as independent application software or a built-in function of the image processing device.

What is claimed is:

1. A method of generating a color profile for converting color values in a device-independent first color space to color values in a device-dependent second color space for the purpose of color adjustment of an output device, comprising the steps of:
(A) executing the mapping of the extra-gamut color value located outside the gamut of said output device among the color values in said first color space into the surface of said gamut;
(B) calculating color difference between said extra-gamut color value before and after the mapping in said step (A);
(C) calculating a correction amount for correcting said extra-gamut color value before the mapping in said step (A), based on said color difference calculated in said step (B) and said extra-gamut color value before the mapping in said step (A);
(D) executing the re-mapping of said extra-gamut color value after the correction by said correction amount calculated in said step (C), in accordance with said step (A); and
(E) generating a color profile for converting said extra-gamut color value before the mapping in said step (A), into the color value in said second color space corresponding to said extra-gamut color value after the re-mapping in said step (D).

2. The method of generating a color profile as claimed in claim 1, wherein
said correction amount calculated in said step (C) is an amount for correcting the hue angle of said extra-gamut color value before the mapping in said step (A).

3. The method of generating a color profile as claimed in claim 2, wherein
said correction amount is calculated in said step (C) by multiplying an initial correction amount defined for each hue angle range where said extra-gamut color value before the mapping in said step (A) belongs to, by a first factor defined for the hue angle of said extra-gamut color value before the mapping in said step (A) and a second factor defined for said color difference calculated in said step (B).

4. The method of generating a color profile as claimed in claim 1, wherein
said correction amount calculated in said step (C) is an amount for correcting the colorfulness and luminosity values of said extra-gamut color values before the mapping in the step (A).

5. The method of generating a color profile as claimed in claim 1, wherein
said step (A) includes the steps of: (A1) dividing the extra-gamut area on the luminosity-colorfulness plane corresponding to the hue angle of said extra-gamut color value, into a plurality of small segments; (A2) determining as the mapping target value for said extra-gamut color value belonging to the high-colorfulness segment faced with the maximum colorfulness point within said gamut among said small segments created in said step (A1), a certain color value within said gamut having a colorfulness value smaller than said maximum colorfulness point; and (A3) executing the mapping of said extra-gamut color value belonging to said high-colorfulness segment into the intersection between a straight line drawn from said mapping target value determined in said step (A2) to said extra-gamut color value, and the outer surface of said gamut.

6. The method of generating a color profile as claimed in claim 1, wherein
said first color space is the L*a*b* color space.

7. The method of generating a color profile as claimed in claim 1, wherein
said first color space is the CIECAM02 color space.

8. An image processing device for generating a color profile for converting color values in a device-independent first color space to color values in a device-dependent second color space for the purpose of color adjustment of an output device, comprising:
a first gamut-mapping unit for executing the mapping of the extra-gamut color value located outside the gamut of said output device among the color values in said first color space into the surface of said gamut;
a color difference calculation unit for calculating a color difference between said extra-gamut color value before and after the mapping executed by said first gamut-mapping unit;
a correction amount calculating unit for calculating a correction amount for correcting said extra-gamut color value before the mapping executed by said first gamut-mapping unit, based on said color difference calculated by said color difference calculation unit and said extra-gamut color value before the mapping executed by said first gamut-mapping unit;
a second gamut-mapping unit for executing the re-mapping of said extra-gamut color value after the correction by said correction amount calculated by said correction amount calculation unit if said extra-gamut color value after the correction is still located outside said gamut; and
a color profile generating unit for generating a color profile for converting said extra-gamut color value before the mapping executed by said first gamut-mapping unit, into the color value in said second color space corresponding to said extra-gamut color value after the re-mapping executed by said second gamut-mapping unit.

9. The image processing device as claimed in claim 8, wherein
said correction amount calculated by said correction amount calculating unit is an amount for correcting the hue angle of said extra-gamut color value before the mapping executed by said first gamut-mapping unit.

10. The image processing device as claimed in claim 9, wherein
said correction amount is calculated by multiplying an initial correction amount defined for each hue angle range where said extra-gamut color value before the mapping executed by said first gamut-mapping unit belongs to, by a first factor defined for the hue angle of said extra-gamut color value before the mapping executed by said first gamut-mapping unit and a second factor defined for said color difference calculated by said color difference calculating unit.

11. The image processing device as claimed in claim 8, wherein
said correction amount calculated by said correction amount calculating unit is a correction amount for correcting the colorfulness and luminosity values of said extra-gamut color value before the mapping executed by said first gamut-mapping unit.

12. The image processing device as claimed in claim 8, wherein
each of said first and second gamut-mapping units includes: an area dividing unit for dividing the extra-gamut area on the luminosity-colorfulness plane corresponding to the hue angle of said extra-gamut color value, into a plurality of small segments; a mapping target determining unit for determining as the mapping target value for said extra-gamut color value belonging to the high colorfulness segment faced with the maximum colorfulness point within said gamut among said small segments created by said area dividing unit, a certain color value within said gamut having a colorfulness value smaller than said maximum colorfulness point; and a color value mapping unit for executing the mapping of said extra-gamut color value belonging to said high-colorfulness segment into the intersection between a straight line drawn from said mapping target value determined in said mapping target determining unit to said extra-gamut color value, and the outer surface of said gamut.

13. The image processing device as claimed in claim 8, wherein
said first color space is the L*a*b* color space.

14. The image processing device as claimed in claim 8, wherein
said first color space is the CIECAM02 color space.

15. A computer readable recording medium storing a program for creating a color profile for converting color values in a device-independent first color space to color values in a device-dependent second color space for the purpose of color adjustment of an output device, said program causing an image processing device to execute the steps of:
(A) mapping the extra-gamut area color value located outside the gamut of said output device among the color values in said first color space into the surface of said gamut;
(B) calculating a color difference between said extra-gamut color value before and after the mapping in said step (A);
(C) calculating a correction amount for correcting said extra-gamut color value before the mapping in said step (A), based on said color difference calculated in said step (B) and said extra-gamut color value before the mapping in said step (A);
(D) executing the re-mapping of said extra-gamut color value after the correction by said correction amount calculated in said step (C), in accordance with said step (A); and
(E) generating a color profile for converting said extra-gamut color value before the mapping in said step (A), into color the value in said second color space corresponding to said extra-gamut color value after the re-mapping in said step (D).

16. The computer readable recording medium as claimed in claim 15, wherein
said correction amount calculated in said step (C) is an amount for correcting the hue angle of said extra-gamut color values before the mapping in said step (A).

17. The computer readable recording medium as claimed in claim 16, wherein
said correction amount is calculated in said step (C) by multiplying an initial correction amount defined for each hue angle range where said extra-gamut color value before the mapping in the step (A) belongs to, by a first factor defined for the hue angle of said extra-gamut color value before the mapping in said step (A) and a second factor defined for said color difference calculated in said step (B).

18. The computer readable recording medium as claimed in claim 15, wherein
said correction amount calculated in said step (C) is an amount for correcting the colorfulness and luminosity values of said extra-gamut color value before the mapping in said step (A).

19. The computer readable recording medium as claimed in claim 15, wherein
said step (A) includes the steps of: (A1) dividing the extra-gamut area on the luminosity-colorfulness plane corresponding to the hue angle of said extra-gamut area color values, into a plurality of small segments; (A2) determining as the mapping target value for said extra-gamut color value belonging to the high-colorfulness segment faced with the maximum colorfulness point within said gamut among said small segments created in said step (A1), a certain color value within said gamut having a colorfulness value smaller than said maximum colorfulness point; and (A3) executing the mapping of said extra-gamut color value belonging to said high-colorfulness segment into the intersection between a straight line drawn from said mapping target value determined in said step (A2) to said extra-gamut color value, and the outer surface of said gamut.

20. The computer readable recording medium as claimed in claim 15, wherein
said first color space is the L*a*b* color space.

21. The computer readable recording medium as claimed in claim 15, wherein
said first color space is the CIECAM02 color space.
